(19) United States
(12) Patent Application Publication
(10) Pub. No.: US 2015/0372294 A1
(43) Pub. Date: Dec. 24, 2015

(54) NEGATIVE ELECTRODE ACTIVE MATERIAL FOR NONAQUEOUS ELECTROLYTE SECONDARY BATTERY, NEGATIVE ELECTRODE FOR NONAQUEOUS ELECTROLYTE SECONDARY BATTERY USING NEGATIVE ELECTRODE ACTIVE MATERIAL, AND NONAQUEOUS ELECTROLYTE SECONDARY BATTERY USING NEGATIVE ELECTRODE

(71) Applicant: SANYO ELECTRIC CO., LTD., Daito-shi, Osaka (JP)

(72) Inventors: Hiroshi Minami, Hyogo (JP); Mai Yokoi, Tokushima (JP); Tatsuya Akira, Hyogo (JP); Naoki Imachi, Hyogo (JP)

(73) Assignee: Sanyo Electric Co., Ltd., Daito-shi, Osaka (JP)

(21) Appl. No.: 14/763,979

(22) PCT Filed: Jan. 23, 2014
(86) PCT No.: PCT/JP2014/000327

§ 371 Date: Jul. 28, 2015

(30) Foreign Application Priority Data
Jan. 29, 2013 (JP) 2013-014279

(51) Int. Cl. H01M 4/36; H01M 4/38; H01M 4/583; H01M 10/0525

(52) U.S. Cl. CPC H01M 4/366; H01M 10/0525; H01M 4/386; H01M 4/583

(57) ABSTRACT

In nonaqueous electrolyte secondary batteries that use silicon or silicon oxide as a negative electrode active material, the initial charge-discharge efficiency and the cycle characteristics are improved. A negative electrode active material particle (13a) is a particulate negative electrode active material used for nonaqueous electrolyte secondary batteries, and includes a base particle (14) composed of silicon or silicon oxide and a conductive coating layer (15) that coats at least part of a surface of the base particle (14). A pore (16) is formed in the particle. The pore (16) preferably includes an interfacial pore (16z) formed between the base particle (14) and the coating layer (15).

### TECHNICAL FIELD

The present invention relates to a negative electrode active material for nonaqueous electrolyte secondary batteries, a negative electrode for nonaqueous electrolyte secondary batteries using the negative electrode active material, and a nonaqueous electrolyte secondary battery using the negative electrode.

### BACKGROUND ART

Silicon (Si) and silicon oxide represented by SiOₓ have a higher capacity per unit volume than carbon materials such as graphite, and thus their application to negative electrode active materials has been considered. In particular, the volume expansion coefficient of SiOₓ in the occlusion of Li⁺ during charging is smaller than that of Si, and thus SiOₓ is promising for early commercialization. For example, PTL 1 proposes a nonaqueous electrolyte secondary battery that uses a negative electrode active material prepared by mixing SiOₓ and graphite.

### CITATION LIST

### Patent Literature

PTL 1: Japanese Published Unexamined Patent Application No. 2010-233245

### SUMMARY OF INVENTION

### Technical Problem

However, nonaqueous electrolyte secondary batteries that use SiOₓ or the like as a negative electrode active material has a lower initial charge-discharge efficiency than nonaqueous electrolyte secondary batteries that use graphite as a negative electrode active material, and therefore the capacity considerably decreases at the beginning of cycles.

### Solution to Problem

The main cause of the above problem is that the volume change of SiOₓ or the like in the charge and discharge is larger than that of graphite. Such a large volume change of an active material is believed to cause, for example, a decrease in the conductivity of an active material layer, which leads to degradation of initial charge-discharge efficiency or the like.

In view of the foregoing, a negative electrode active material for a nonaqueous electrolyte secondary battery according to the present invention is a particulate negative electrode active material used for a nonaqueous electrolyte secondary battery. The negative electrode active material includes a base particle composed of silicon or silicon oxide and a conductive coating layer that coats at least part of a surface of the base particle. A pore is formed in the particle.

A negative electrode for a nonaqueous electrolyte secondary battery according to the present invention is composed of a mixture of the above-described negative electrode active material and a conductive carbon material.

A nonaqueous electrolyte secondary battery according to the present invention includes the negative electrode containing the negative electrode active material, a positive electrode, and a nonaqueous electrolyte.

### Advantageous Effects of Invention

According to the present invention, in nonaqueous electrolyte secondary batteries that use Si or SiOₓ as a negative electrode active material, the initial charge-discharge efficiency and the cycle characteristics can be improved.

### BRIEF DESCRIPTION OF DRAWINGS

FIG. 1 is a cross-sectional view illustrating a negative electrode according to an embodiment of the present invention.

FIG. 2 is a cross-sectional view illustrating a negative electrode active material particle according to an embodiment of the present invention.

FIG. 3 is a cross-sectional view illustrating a negative electrode active material particle according to another embodiment of the present invention.

FIG. 4 is a cross-sectional view illustrating a negative electrode active material particle according to another embodiment of the present invention.

FIG. 5 is a first electron micrograph showing the cross-section of negative electrode active material particles used in Examples.

FIG. 6 is a second electron micrograph showing the cross-section of negative electrode active material particles used in Examples.

FIG. 7 is an electron micrograph showing the cross-section of negative electrode active material particles used in Comparative Examples.

### DESCRIPTION OF EMBODIMENTS

Hereafter, embodiments of the present invention will be described in detail.

The drawings referred to in the description of the embodiments are schematically illustrated. For example, the dimensional ratio of an element illustrated in the drawings may be different from that of the actual element. The specific dimensional ratio or the like should be judged in consideration of the following description.

In this Description, the meaning of “substantially **” is that, when “substantially the same” is taken as an example, “substantially the same” is intended to include not only “exactly the same”, but also “virtually the same”.

A nonaqueous electrolyte secondary battery according to an embodiment of the present invention includes a positive electrode containing a positive electrode active material, a negative electrode containing a negative electrode active material, and a nonaqueous electrolyte containing a nonaqueous solvent. A separator is suitably disposed between the positive electrode and the negative electrode. For example, the nonaqueous electrolyte secondary battery has a structure in which an electrode body obtained by winding a positive electrode and a negative electrode with a separator disposed therebetween and a nonaqueous electrolyte are accommodated in an exterior body.

### [Positive Electrode]

The positive electrode suitably includes a positive electrode current collector and a positive electrode active material layer formed on the positive electrode current collector. The positive electrode current collector is composed of, for example, a conductive thin film such as a metal foil or alloy foil of aluminum or the like which is stable in the potential range of a positive electrode or a film including a metal surface layer composed of aluminum or the like. The positive electrode active material layer preferably contains a conductive material and a binding agent, in addition to the positive electrode active material.

The positive electrode active material is not particularly limited, but is preferably a lithium transition metal oxide. The lithium transition metal oxide may contain a non-transition metal element such as Mg or Al. Specific examples of the lithium transition metal oxide include lithium cobaltate, olivine lithium phosphate such as lithium iron phosphate, and lithium transition metal oxides such as Ni—Co—Mn, Ni—Mn—Al, and Ni—Co—Al. These positive electrode active materials may be used alone or in combination of two or more.

The conductive material may be a carbon material such as carbon black, acetylene black, Ketjenblack, or graphite or a mixture of two or more of the foregoing. The binding agent may be polytetrafluoroethylene, polyvinylidene fluoride, polyvinyl acetate, polyacrylonitrile, or polyvinyl alcohol or a mixture of two or more of the foregoing.

### [Negative Electrode]

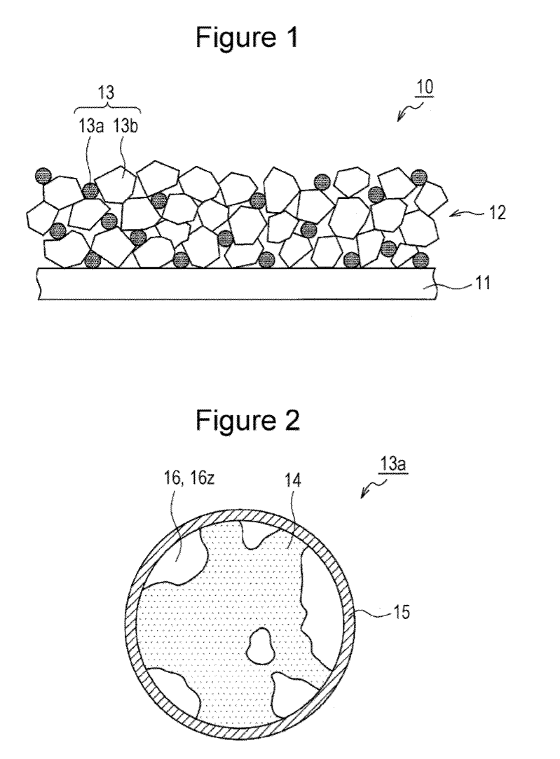

As illustrated in FIG. 1, a negative electrode 10 suitably includes a negative electrode current collector 11 and a negative electrode active material layer 12 formed on the negative electrode current collector 11. The negative electrode current collector 11 is composed of, for example, a conductive thin film such as a metal foil or alloy foil of copper or the like which is stable in the potential range of a negative electrode or a film including a metal surface layer composed of copper or the like. The negative electrode active material layer 12 suitably includes a binding agent (not illustrated) in addition to the negative electrode active material 13. The binding agent may be polytetrafluoroethylene or the like as in the case of the positive electrode, but is preferably styrene-butadiene rubber (SBR), polyimide, or the like. The binding agent may be used together with a thickener such as carboxymethyl cellulose.

A negative electrode active material 13a is used as the negative electrode active material 13. The negative electrode active material 13a includes a base particle 14 composed of silicon (Si) or silicon oxide (SiOₓ) and a conductive coating layer 15 that coats at least part of the surface of the base particle 14. The negative electrode active material 13a may be used alone as the negative electrode active material 13, but is suitably used in combination with another negative electrode active material 13b whose volume change due to charge and discharge is smaller than that of the negative electrode active material 13a in view of achieving both an increase in capacity and an improvement in cycle characteristics. The negative electrode active material 13b is not particularly limited, but is preferably a carbon-based active material such as graphite or hard carbon.

In the case where the negative electrode active material 13a and the negative electrode active material 13b are used in combination, for example, if the negative electrode active material 13b is graphite, the mass ratio of the negative electrode active material 13a to the graphite is preferably 1:99 to 20:80. When the mass ratio is within the above range, both an increase in capacity and an improvement in cycle characteristics are easily achieved. If the percentage of the mass of the negative electrode active material 13a relative to the total mass of the negative electrode active material 13 is less than 1 mass %, an effect of increasing the capacity by adding the negative electrode active material 13a is reduced.

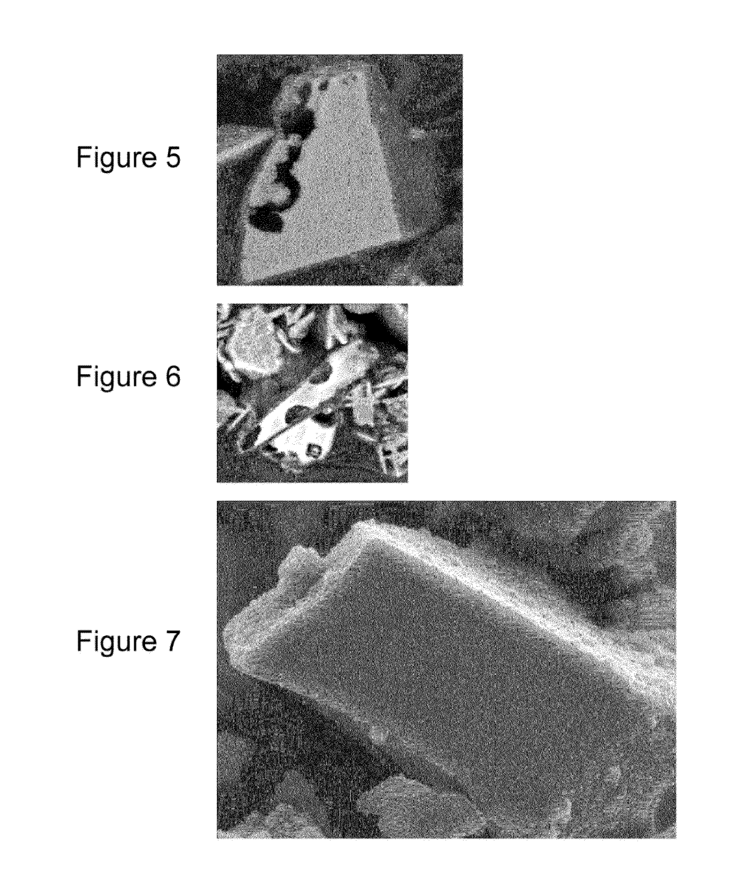

Hereafter, the negative electrode active material 13a will be described in detail with reference to FIG. 2 to FIG. 4. Electron micrographs in FIG. 5 to FIG. 7 will be suitably used for reference.

As illustrated in FIG. 2, the negative electrode active material 13a has a particulate shape in which the coating layer 15 is formed on the surface of the base particle 14 (hereafter referred to as a “negative electrode active material particle 13a”). Pores 16 are formed in the negative electrode active material particle 13a. The pores 16 have a role in reducing the volume change of the base particle 14 due to charge and discharge. Specifically, as described below, the formation of the pores 16 considerably improves the initial charge-discharge efficiency and the cycle characteristics in a nonaqueous electrolyte secondary battery that uses the negative electrode active material particle 13a.

For example, many of the negative electrode active material particles 13a have sharp corners and thus have various shapes such as a block shape, a flat shape, an elongated rod shape, and a needle-like shape (refer to FIGS. 5 and 6). The particle size of the negative electrode active material particle 13a is substantially equal to the particle size of the base particle 14 in which the pores 16 are not formed because the thickness of the coating layer 15 is small as described below.

As described above, the base particle 14 is composed of Si or SiOₓ. SiOₓ (preferably 0<x≦1.5) has, for example, a structure in which Si is dispersed in an amorphous SiO₂ matrix. The presence of the dispersed Si can be confirmed through observation with a transmission electron microscope (TEM). Si or SiOₓ can occlude a larger amount of Li⁺ and has a higher capacity per unit volume than carbon materials such as graphite, and thus contributes to an increase in the capacity. However, Si or SiOₓ causes a large volume change due to charge and discharge and also has a characteristic unsuitable for negative electrode active materials, such as low electron conductivity. In the negative electrode active material particle 13a, such a drawback is overcome by employing the coating layer 15 and the pores 16.

SiOₓ constituting the base particle 14 may contain lithium silicate (e.g., Li₄SiO₄, Li₂SiO₃, Li₂Si₂O₅, and Li₈SiO₆) in the particle.

The average particle size of the base particles 14 is preferably 1 to 30 μm and more preferably 2 to 15 μm in view of achieving an increase in capacity. In this Description, the term “average particle size” refers to a particle size (volume-average particle size, Dv₅₀) at which the volume-based cumulative distribution reaches 50% in the particle size distribution measured by a laser diffraction/scattering method. Dv₅₀ can be measured with, for example, “LA-750” manufactured by HORIBA, Ltd. If the average particle size of the base particles 14 is excessively decreased, the surface area of the particles increases. As a result, the amount of reaction with an electrolyte increases, which tends to decrease the capacity. If the average particle size is excessively increased, the volume change due to charge and discharge increases. As a result, the total volume of the pores 16 needs to be increased, which tends to decrease the capacity per unit volume.

The coating layer 15 is a conductive layer composed of a material having higher conductivity than Si and SiOₓ. The conductive material constituting the coating layer 15 is preferably an electrochemically stable material and is preferably at least one selected from the group consisting of carbon materials, metals, and metal compounds.

The carbon material may be carbon black, acetylene black, Ketjenblack, or graphite or a mixture of two or more of the foregoing as in the case of the conductive material of the positive electrode active material layer. The metal may be Cu, Ni, or an alloy of Cu and Ni, which is stable in the negative electrode 10. The metal compound may be, for example, a Cu compound or a Ni compound.

The coating layer 15 is suitably formed so as to coat substantially the entire surface of the base particle 14. Herein, the term “coat the entire surface of the base particle 14” does not mean that the coating layer 15 is formed in contact with substantially the entire surface of the base particle 14, but means that, when the surface of the negative electrode active material particle 13a is observed, substantially the entire base particle 14 is covered with the coating layer 15. In other words, it is preferable that the base particle 14 be not widely exposed on the surface of the negative electrode active material particle 13a. When interfacial pores 16z described below are formed, a portion of the coating layer 15 is formed in contact with the base particle 14 and the remaining portion is formed away from the surface of the base particle 14. Note that some cracks are observed in streaks on the surface of the negative electrode active material particle 13a, for example, on the coating layer 15 after the charge and discharge.

The average thickness of the coating layer 15 is preferably 1 to 200 nm and more preferably 5 to 100 nm in consideration of ensuring of conductivity and diffusion of Li⁺ to SiOₓ or the like constituting the base particle 14. The coating layer 15 suitably has a substantially uniform thickness across its entire region. The average thickness of the coating layer 15 can be measured by cross-sectional observation of the negative electrode active material particle 13a using a scanning electron microscope (SEM), a transmission electron microscope (TEM), or the like. If the thickness of the coating layer 15 is excessively decreased, the conductivity decreases, which makes it difficult to uniformly coat the base particle 14. If the thickness of the coating layer 15 is excessively increased, the diffusion of Li⁺ to the base particle 14 is inhibited, which tends to decrease the capacity.

The coating layer 15 can be formed by a typical method such as a CVD method, a sputtering method, or a plating method (electroplating, electroless plating). For example, when a coating layer 15 composed of a carbon material is formed on the surface of each of SiOₓ particles by a CVD method, SiOₓ particles and hydrocarbon gas are heated in a gaseous phase and carbon generated by pyrolysis of the hydrocarbon gas is deposited on the SiOₓ particles. In this case, before the formation of the pores 16, the coating layer 15 is formed in contact with each of the SiOₓ particles. Examples of the hydrocarbon gas include methane gas and acetylene gas.

As described above, the pores 16 are formed in the negative electrode active material particle 13a. In other words, the pores 16 are present inside the negative electrode active material particle 13a surrounded by the coating layer 15 serving as a shell of the particle. In the negative electrode active material particle 13a, an SiOₓ particle is not densely packed in the shell (refer to FIGS. 5 and 6) unlike known graphite-coated SiOₓ particles (refer to FIG. 7). In the negative electrode active material particle 13a, a single large pore 16 may be formed, but many pores 16 are preferably formed to efficiently reduce the volume change due to charge and discharge.

The percentage (hereafter referred to as a “porosity”) of the total volume of the pores 16 relative to the total volume of the negative electrode active material particle 13a is preferably 1 to 60% and more preferably 5 to 50%. When the porosity is within the above range, the volume change due to charge and discharge can be efficiently reduced. Even if the size of the pores 16 is small, the effect of reducing the volume change is produced, but it is difficult to observe the effect in the evaluation of cycle characteristics or the like. An excessively high porosity is not preferred in view of an increase in capacity because the capacity per unit volume decreases.

The porosity of the negative electrode active material particles 13a can be measured by, for example, the following method.

(1) Method for Determining Porosity from Density

The bulk density of particles is measured before and after a pore-forming treatment, and the porosity is calculated using the following formula.

Porosity (%)=1−(bulk density after treatment/bulk density before treatment)

Since the particle surface state and the particle size do not change before and after the treatment, the porosity can be determined from the difference of the ratio of bulk densities. The bulk density before the treatment can also be calculated on the basis of the composition of compounds constituting particles, the composition ratio, and the particle size.

(2) Method for Determining Porosity with SEM

The cross-section of the negative electrode active material particle 13a is exposed using, for example, an ion milling system (ex. IM4000) manufactured by Hitachi High-Technologies Corporation, and the cross-section of the particle is observed with a SEM (e.g., refer to FIG. 5). The porosity of the cross-section of the particle is measured. The average of the porosities of 30 particles is defined as the porosity of the negative electrode active material particles 13a.

The pores 16 suitably include interfacial pores 16z formed between the base particle 14 and the coating layer 15. That is, the interfacial pores 16z are pores that are formed in a region including an interface between the surface of the base particle 14 and the inner surface of the coating layer 15 that faces the particle, and are surrounded by the base particle 14 and the coating layer 15. In addition to the interfacial pores 16z, the pores 16 include pores surrounded by only the base particle 14. However, a pore that seems to be the latter pore in a single cross-sectional observation with a SEM is sometimes an interfacial pore 16z in reality.

The interfacial pores 16z are particularly suitably present at a percentage of 50 vol % or more relative to the total volume of the pores 16. The base particle 14 undergoes volume expansion through occlusion of Li⁺, and this expansion easily occurs toward the outside of the base particle 14. Therefore, the interfacial pores 15 that are present on the outer side of the base particle 14 can efficiently absorb the expansion. The interfacial pores 16z are present at a percentage of more preferably 60 vol % or more and particularly preferably 70 vol % or more. Substantially all the pores 16 may be the interfacial pores 16z.

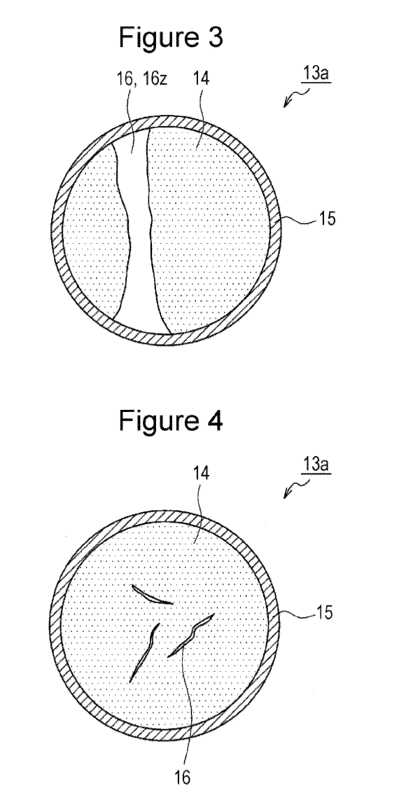

As illustrated in FIG. 3, each of the pores 16 may have a shape that separates the base particle 14. Herein, the base particle 14 seems to be separated into two pieces by the pore 16 in a single cross-sectional observation with a SEM (e.g., refer to FIG. 5), but portions separated in the cross-section are often connected to each other in another cross-sectional observation.

As illustrated in FIG. 4, each of the pores 16 may have a shape of a crack that is present inside the base particle 14. For example, a large number of the crack-shaped pores 16 may be formed in the base particle 14. The crack-shaped pores 16 may be interfacial pores 16z that extend to the surface of the base particle 14.

The pores 16 can be formed by, for example, the following method.

(1) After a coating layer 15 is formed on a base particle 14, part of the base particle 14 is eluted using an agent that can dissolve the base particle 14, but does not damage the coating layer 15.

Agent: alkaline solution, etc. (e.g., aqueous LiOH, KOH, or NaOH solution)

Treatment conditions: An object to be treated is immersed in the agent, for example, at 60° C. for 1 hour.

By changing the concentration of the agent, the treatment time, and the treatment temperature, the porosity can be controlled. For example, when the treatment time is increased, the porosity is generally increased.

(2) A material that can be selectively removed (hereafter referred to as a “pore-forming material”) is attached to or formed on the base particle 14, and then a coating layer 15 is formed and only the pore-forming material is removed. In this case, the removing method can be suitably selected in accordance with the types of pore-forming materials. For example, when the pore-forming material is a resin, the resin can be removed by elution with an organic solvent or by decomposition at high temperature.

### [Nonaqueous Electrolyte]

The nonaqueous electrolyte contains a nonaqueous solvent and an electrolyte salt dissolved in the nonaqueous solvent. The nonaqueous electrolyte is not limited to a liquid electrolyte (nonaqueous electrolytic solution), and may be a solid electrolyte that uses a gel polymer or the like. The nonaqueous solvent may be, for example, an ester, an ether, a nitrile (e.g., acetonitrile), or an amide (e.g., dimethylformamide) or a mixed solvent containing two or more of the foregoing.

Examples of the ester include cyclic carbonates such as ethylene carbonate (EC), propylene carbonate, and butylene carbonate; chain carbonates such as dimethyl carbonate, methyl ethyl carbonate, diethyl carbonate (DEC), methyl propyl carbonate, ethyl propyl carbonate, and methyl isopropyl carbonate; and carboxylates such as methyl acetate, ethyl acetate, propyl acetate, methyl propionate, ethyl propionate, and γ-butyrolactone.

Examples of the ether include cyclic ethers such as 1,3-dioxolane, tetrahydrofuran, 2-methyltetrahydrofuran, propylene oxide, 1,2-butylene oxide, 1,3-dioxane, furan, and 1,8-cineole; and chain ethers such as 1,2-dimethoxyethane, ethyl vinyl ether, ethyl phenyl ether, 1,2-diethoxyethane, 1,2-dibutoxyethane, diethylene glycol dimethyl ether, 1,1-dimethoxymethane, 1,1-diethoxyethane, and triethylene glycol dimethyl ether.

Among the solvents listed above, at least a cyclic carbonate is preferably used as the nonaqueous solvent, and both a cyclic carbonate and a chain carbonate are more preferably used. The nonaqueous solvent may also be a halogen substitution product obtained by substituting hydrogen atoms of a solvent with halogen atoms such as fluorine atoms.

The electrolyte salt is preferably a lithium salt. Examples of the lithium salt include LiPF₆, LiBF₄, LiAsF₆, LiN(SO₂CF₃)₂, LiN(SO₂CF₅)₂, and LiPF₆₋ₓ(CₙF₂ₙ₊₁)ₓ (1<x<6, n: 1 or 2). These lithium salts may be used alone or in combination of two or more. The concentration of the lithium salt is preferably 0.8 to 1.8 mol per 1 L of the nonaqueous solvent.

### [Separator]

A porous sheet having ion permeability and an insulating property is used as the separator. Specific examples of the porous sheet include microporous membranes, woven fabrics, and nonwoven fabrics. The separator is suitably made of a polyolefin such as polyethylene or polypropylene.

### EXAMPLES

The present invention will be further described based on Examples, but is not limited to these Examples.

### Example 1

### Preparation of Negative Electrode Active Material Particles B1

A coating layer was formed on the entire surface of each of SiOₓ particles (x=0.93, Dv₅₀: 5.0 μm) serving as base particles by a CVD method so as to have an average thickness of 50 nm and a percentage of 10 mass % (mass of coating layer/mass of coated particle A1). Thus, SiOₓ particles A1 on which the coating layer was formed (hereafter referred to as “coated particles A1”) were prepared. The coating layer was composed of a conductive carbon material and formed at 800° C. using an acetylene gas as a raw material gas.

The coated particles A1 were immersed in a 1 M aqueous LiOH solution at 60° C. for 1 hour to form pores in the particles. Subsequently, the particles subjected to the immersion were collected by filtration, and the collected particles were dried to prepare negative electrode active material particles B1.

The negative electrode active material particles B1 had a porosity of 30%. The porosity was calculated from the difference of the ratio of bulk densities before and after the immersion (the same applies hereafter).

FIGS. 5 and 6 show cross-sectional SEM images of the negative electrode active material particles B1. As is clear from the SEM images, many pores are formed in the negative electrode active material particles B1. Half or more or substantially all of the pores are present between the base particle and the coating layer.

### [Production of Negative Electrode]

The negative electrode active material particles B1 and polyimide serving as a binding agent were mixed at a mass ratio of 95:5, and N-methyl-pyrrolidone (NMP) was further added as a diluent solvent. The mixture was stirred with a mixer (ROBOMIX manufactured by PRIMIX Corporation) to prepare a slurry for forming a negative electrode active material layer.

Subsequently, the slurry was applied onto one surface of a copper foil to be a negative electrode current collector so that the mass of the negative electrode active material layer per 1 m² was 25 g. The copper foil was then dried at 105° C. in the air and rolled to produce a negative electrode. The packing density of the negative electrode active material layer was 1.50 g/mL.

### [Preparation of Nonaqueous Electrolytic Solution]

LiPF₆ was added to a nonaqueous solvent prepared by mixing EC and DEC at a ratio of EC:DEC=3:7 (volume ratio) so that the concentration of LiPF₆ was 1.0 mol/L. Thus, a nonaqueous electrolytic solution was prepared.

### [Production of Test Cell T1]

An electrode body was produced in an inert atmosphere using the negative electrode having a peripheral portion to which a Ni tab was attached, a Li metal foil, and a polyethylene separator. In the electrode body, the negative electrode and the Li metal foil were disposed so as to face each other with the separator disposed therebetween. The electrode body was inserted into an exterior body composed of an aluminum laminate sheet, and then the nonaqueous electrolytic solution was injected. The opening of the exterior body was sealed to produce a test cell T1.

### Example 2

Negative electrode active material particles B2 were prepared in the same manner as in Example 1, except that the coated particles A1 were immersed in a 1 M aqueous LiOH solution at 25° C. for 10 minutes. A test cell T2 was produced using the negative electrode active material particles B2. The porosity of the negative electrode active material particles B2 was 1%.

### Example 3

Negative electrode active material particles B3 were prepared in the same manner as in Example 1, except that the coated particles A1 were immersed in a 1 M aqueous LiOH solution at 60° C. for 4 hours. A test cell T3 was produced using the negative electrode active material particles B3. The porosity of the negative electrode active material particles B3 was 58%.

### Example 4

A coating layer was formed on the entire surface of each of Si particles (Dvs₅₀: 5.0 μm) serving as base particles by a CVD method so as to have an average thickness of 50 nm and a percentage of 10 mass %. Thus, Si particles A4 on which the coating layer was formed were prepared. Except for this, negative electrode active material particles B4 were prepared in the same manner as in Example 1. A test cell T4 was produced using the negative electrode active material particles B4. The porosity of the negative electrode active material particles B4 was 42%.

### Example 5

Negative electrode active material particles B5 were prepared in the same manner as in Example 1, except that SiOₓ particles (x=0.93, Dv₅₀: 1.0 μm) were used as base particles. A test cell T5 was produced using the negative electrode active material particles B5. The porosity of the negative electrode active material particles B5 was 45%.

### Example 6

Negative electrode active material particles B6 were prepared in the same manner as in Example 1, except that SiOₓ particles (x=0.93, Dvs₅₀: 30.0 μm) were used as base particles. A test cell T6 was produced using the negative electrode active material particles B6. The porosity of the negative electrode active material particles B6 was 23%.

### Example 7

Negative electrode active material particles B7 were prepared in the same manner as in Example 1, except that a Cu metal layer having an average thickness of 100 nm and a percentage of 5 mass % was formed as the coating layer. A test cell T7 was produced using the negative electrode active material particles B7. The porosity of the negative electrode active material particles B7 was 15%. The Cu metal layer was formed by an electroless plating method.

### Comparative Example 1

Negative electrode active material particles C1 were prepared in the same manner as in Example 1, except that the coated particles A1 were not immersed in the aqueous LiOH solution. A test cell R1 was produced using the negative electrode active material particles C1. The porosity of the negative electrode active material particles C1 was 0%.

FIG. 7 shows a cross-sectional SEM image of the negative electrode active material particles C1. As is clear from the SEM image, the negative electrode active material particles C1 had no pores at all.

### Comparative Example 2

Negative electrode active material particles C2 were prepared in the same manner as in Example 4, except that the Si particles A4 on which the coating layer was formed were not immersed in the aqueous LiOH solution. A test cell R2 was produced using the negative electrode active material particles C2. The porosity of the negative electrode active material particles C2 was 0%.

### <Evaluation of Battery Performance>

The test cells T1 to T7, R1, and R2 were evaluated in terms of initial charge-discharge efficiency and cycle characteristics. Tables 1 to 4 show the evaluation results together with the constituent materials and the like. Table 2 is a table summarized to facilitate the understanding of the relationship between the porosity and the evaluation results. Table 3 is a table summarized to facilitate the understanding of the relationship between the average particle size of the base particles and the evaluation results. Table 4 is a table summarized to facilitate the understanding of the relationship between the constituent materials of the coating layer and the evaluation results.

### [Initial Charge-Discharge Efficiency]

(1) Charge: Constant current charge was performed at a current of 0.2 It until the voltage reached 0 V. Subsequently, constant current charge was performed at a current of 0.05 It until the voltage reached 0 V.
(2) Discharge: Constant current discharge was performed at a current of 0.2 It until the voltage reached 1.0 V.
(3) Pause: The pause time between the charge and the discharge was 10 minutes.

The percentage of the first-cycle discharge capacity relative to the first-cycle charge capacity was defined as an initial charge-discharge efficiency. Initial charge-discharge efficiency (%)=(First-cycle discharge capacity/First-cycle charge capacity)×100

### [Cycle Test]

A cycle test was performed for each of the test cells under the above charge-discharge conditions.

The percentage of the tenth-cycle discharge capacity relative to the first-cycle discharge capacity was defined as cycle characteristics. Cycle characteristics (%)=(Tenth-cycle discharge capacity/First-cycle discharge capacity)×100

TABLE 1

| | Base particles | | | Initial charge- | Cycle |
|---|---|---|---|---|---|
| | (average particle | Coating | Poros- | discharge | charac- |
| | size) | layer | ity | efficiency | teristics |
| T1 | SiOₓ (5.0 μm) | Carbon | 30% | 73% | 37% |
| T2 | SiOₓ (5.0 μm) | Carbon | 1% | 70% | 15% |
| T3 | SiOₓ (5.0 μm) | Carbon | 58% | 73% | 45% |
| T4 | Si (5.0 μm) | Carbon | 42% | 96% | 46% |
| T5 | SiOₓ (1.0 μm) | Carbon | 45% | 69% | 26% |
| T6 | SiOₓ (30.0 μm) | Carbon | 23% | 72% | 39% |
| T7 | SiOₓ (5.0 μm) | Copper | 15% | 69% | 24% |
| R1 | SiOₓ (5.0 μm) | Carbon | 0% | 67% | 7% |
| R2 | Si (5.0 μm) | Carbon | 0% | 92% | 3% |

TABLE 2

| | | | Initial charge- | Cycle |
|---|---|---|---|---|
| | Base particles | Porosity | discharge efficiency | characteristics |
| T1 | SiOₓ | 30% | 73% | 37% |
| T2 | | 1% | 70% | 15% |
| T3 | | 58% | 73% | 45% |
| R1 | | 0% | 67% | 7% |
| T4 | Si | 42% | 96% | 46% |
| R2 | | 0% | 92% | 3% |

TABLE 3

| | | | Initial charge- | |
|---|---|---|---|---|
| | Average particle size | Poros- | discharge | Cycle |
| | of base particles | ity | efficiency | characteristics |
| T5 | 1.0 μm | 45% | 69% | 26% |
| T1 | 5.0 μm | 30% | 73% | 37% |
| T6 | 30.0 μm | 23% | 72% | 39% |
| R1 | 5.0 μm | 0% | 67% | 7% |

TABLE 4

| | | | Initial charge- | Cycle |
|---|---|---|---|---|
| | Coating layer | Porosity | discharge efficiency | characteristics |
| T1 | Carbon | 30% | 73% | 37% |
| T7 | Copper | 15% | 69% | 24% |
| R1 | Carbon | 0% | 67% | 7% |

As is clear from Table 2, the initial charge-discharge efficiency and the cycle characteristics are improved by forming pores in the negative electrode active material particles including SiOₓ base particles or Si base particles. The characteristics are improved by introducing pores for both of SiOₓ and Si. In the case of SiOₓ, when the porosity is about 30 to 60%, both the characteristics have good values. In consideration of also achieving an increase in capacity, the porosity is preferably, for example, about 30% (about 20 to 40%). Pores, in particular, interfacial pores can absorb the volume expansion of SiOₓ or the like due to charge and discharge and thus suppress, for example, a decrease in conductivity due to the considerable volume change of the negative electrode active material layer. That is, the volume expansion as a whole is smaller in the negative electrode active material particles in Examples than in the negative electrode active material particles in Comparative Examples in which pores are not formed.

As is clear from Table 3, the initial charge-discharge efficiency and the cycle characteristics are improved regardless of the average particle size of the base particles or the average particle size of the negative electrode active material particles. However, if the particle size is small, the improvement efficiency tends to decrease because of an increase in the amount of reaction with an electrolyte. In consideration of also achieving an increase in capacity, the average particle size is preferably, for example, about 5 μm (about 3 to 10 μm).

As is clear from Table 4, the initial charge-discharge efficiency and the cycle characteristics are improved regardless of the constituent materials of the coating layer.

### Example 8

### Production of Positive Electrode

Lithium cobaltate, acetylene black (HS100 manufactured by DENKI KAGAKU KOGYO KABUSHIKI KAISHA), and polyvinylidene fluoride were mixed at a mass ratio of 95:2.5:2.5, and NMP was added thereto. The mixture was stirred with a mixer (T.K. HIVIS MIX manufactured by PRIMIX Corporation) to prepare a slurry for forming a positive electrode active material layer.

Subsequently, the slurry was applied onto both surfaces of an aluminum foil to be a positive electrode current collector so that the mass of the positive electrode active material layer per 1 m² was 42 g. The aluminum foil was then dried at 105° C. in the air and rolled to produce a positive electrode. The packing density of the active material layer was 3.6 g/mL.

### [Production of Negative Electrode]

The negative electrode active material particles B1 and graphite were mixed at a mass ratio of 5:95 to prepare a negative electrode active material. The negative electrode active material, carboxymethyl cellulose (CMC, manufactured by Daicel FineChem Ltd., #1380, degree of substitution: 1.0 to 1.5), and SBR were mixed at a mass ratio of 97.5:1.0:1.5, and water was added as a diluent solvent. The mixture was stirred with a mixer (T.K. HIVIS MIX manufactured by PRIMIX Corporation) to prepare a slurry for forming a negative electrode active material layer.

Subsequently, the slurry was applied onto one surface of a copper foil to be a negative electrode current collector so that the mass of the negative electrode active material layer per 1 m² was 190 g. The copper foil was then dried at 105° C. in the air and rolled to produce a negative electrode. The packing density of the negative electrode active material layer was 1.60 g/mL.

### [Production of Test Cell T8]

A tab was attached to each of the electrodes. An electrode body was produced by winding the positive electrode and the negative electrode in a spiral manner with the separator disposed therebetween so that the tabs were located in outermost peripheral portions. The electrode body was inserted into an exterior body composed of an aluminum laminate sheet and vacuum-dried at 105° C. for 2 hours. Subsequently, the nonaqueous electrolytic solution was injected. The opening of the exterior body was sealed to produce a test cell T8. The design capacity of the test cell T8 was 800 mAh.

### Example 8

A test cell T9 was produced in the same manner as in Example 9, except that the negative electrode active material particles B1 and graphite were mixed at a mass ratio of 20:80.

### Comparative Example 3

A negative electrode was produced in the same manner as in Example 8, except that the negative electrode active material particles C1 were used instead of the negative electrode active material particles B1. A test cell R3 was produced using the negative electrode.

### Comparative Example 4

A negative electrode was produced in the same manner as in Example 9, except that the negative electrode active material particles C1 were used instead of the negative electrode active material particles B1. A test cell R4 was produced using the negative electrode.

### <Evaluation of Battery Performance>

The test cells T8, T9, R3, and R4 were evaluated in terms of initial charge-discharge efficiency and cycle life. Table 5 shows the mixing ratio of SiOₓ and the evaluation results.

### [Initial Charge-Discharge Efficiency]

(1) Constant current charge was performed at a current of 1 It (800 mA) until the voltage of the battery reached 4.2 V. Subsequently, constant voltage charge was performed at a constant voltage of 4.2 V until the current reached 1/20 It (40 mA).
(2) Constant current discharge was performed at a current of 1 It (800 mA) until the voltage of the battery reached 2.75 V.
(3) The pause time between the charge and the discharge was 10 minutes.

The percentage of the first-cycle discharge capacity relative to the first-cycle charge capacity was defined as an initial charge-discharge efficiency. Initial charge-discharge efficiency (%)=(First-cycle discharge capacity/First-cycle charge capacity)×100

### [Cycle Test]

A cycle test was performed for each of the test cells under the above-described charge-discharge conditions.

The number of cycles until the capacity reached 80% of the first-cycle discharge capacity was measured and defined as a cycle life. The cycle life is an index based on the assumption that the cycle life of the test cell R3 is 100.

TABLE 5

| | | Initial charge- | Cycle |
|---|---|---|---|
| | Mixing ratio of SiOₓ | discharge efficiency | life |
| T8 | 5% | 89% | 124 |
| R3 | | 87% | 100 |
| R9 | 20% | 83% | 54 |
| R4 | | 80% | 32 |

As is clear from Table 5, even when the negative electrode active material particles and graphite are mixed, the initial charge-discharge efficiency and the cycle life are improved by introducing pores in the particles. In particular, the improvement efficiency for the characteristics tends to increase as the mixing ratio of SiOₓ increases.

### REFERENCE SIGNS LIST

10 negative electrode
11 negative electrode current collector
12 negative electrode active material layer
13,13a,13b negative electrode active material
14 base particle
15 coating layer
16 pore
16z interfacial pore

1. A particulate negative electrode active material used for a nonaqueous electrolyte secondary battery the negative electrode active material comprising:
a particle composed of silicon or silicon oxide; and
a conductive coating layer that coats at least part of a surface of the particle,
wherein pores are formed in the particle.

2. The negative electrode active material according to claim 1,
wherein the pores include an interfacial pore formed between the particle and the coating layer.

3. The negative electrode active material according to claim 2,
wherein the interfacial pore accounts for 50 vol % or more of a total volume of the pores.

4. The negative electrode active material according to claim 1,
wherein the particle has an average particle size of 1 to 30 μm.

5. The negative electrode active material according to claim 1,
wherein a volume percentage of the pores relative to the particle is 1 to 60%.

6. The negative electrode active material according to claim 1,
wherein the coating layer is composed of at least one selected from the group consisting of a carbon material, a metal, and a metal compound.

7. A negative electrode for a nonaqueous electrolyte secondary battery, comprising:
a negative electrode current collector, and
a negative electrode active material layer that is formed on the negative electrode current collector and that contains the negative electrode active material according to claim 1.

8. The negative electrode for a nonaqueous electrolyte secondary battery according to claim 7,
wherein the negative electrode active material layer further contains a carbon-based negative electrode active material.

9. A nonaqueous electrolyte secondary battery comprising the negative electrode according to claim 7, a positive electrode, and a nonaqueous electrolyte.
